(19) United States
(12) Patent Application Publication
(10) Pub. No.: US 2024/0046048 A1
(43) Pub. Date: Feb. 8, 2024

(54) SYNCHRONIZING TRANSLATION WITH SOURCE MULTIMEDIA

(71) Applicant: INTERNATIONAL BUSINESS MACHINES CORPORATION, ARMONK, NY (US)

(72) Inventors: Sarah Packowski, Ottawa (CA); Sharyn Richard, Norton, MA (US)

(21) Appl. No.: 17/816,941

(22) Filed: Aug. 2, 2022

(51) Int. Cl. G06F 40/51; G06F 40/58; G11B 27/10; G11B 27/031; G10L 15/02; G10L 25/57; G10L 15/22; G10L 15/08

(52) U.S. Cl. CPC G06F 40/51; G06F 40/58; G11B 27/10; G11B 27/031; G10L 15/02; G10L 25/57; G10L 15/22; G10L 15/08

(57) ABSTRACT

A method, a computer program product, and a system for synchronizing a translation with source multimedia including obtaining source multimedia with a source communication in a first language. A translation of the source communication is generated in a second language. Features of the translation and the source communication are analyzed. The translation is correlated with the source communication. Differences are detected between the analyzed features of the correlated translation and source communication. At least one of the translation and the source communication are modified based on the detected differences.

### STATEMENT REGARDING PRIOR DISCLOSURES

The following disclosure is submitted under 35 U.S.C. § 102(b)(1)(A):

DISCLOSURE(S): GRACE PERIOD DISCLOSURE, PACKOWSKI et al., “Using IBM Watson Services to Process Video to Streamline Business Processes and Improve Customer Experience”, CASCON'21, Nov. 22-25, 2021, Toronto, Canada, pages 1-6.

### BACKGROUND

Exemplary embodiments of the present inventive concept relate to synchronizing a translation, and more particularly, to synchronizing a translation with source multimedia.

Multimedia (e.g., text, audio, video) is produced for a variety of different purposes (e.g., instruction, education, business, entertainment, etc.). Initially, multimedia may be produced in a singular original language and media type. In many cases, multimedia is subsequently translated into at least one other language and/or media type for broader accessibility and audience dissemination.

### SUMMARY

Exemplary embodiments of the present inventive concept relate to a method, a computer program product, and a system for synchronizing a translation with source multimedia.

According to an exemplary embodiment of the present inventive concept, a method is provided for synchronizing a translation with source multimedia. The method includes obtaining source multimedia with a source communication in a first language. A translation of the source communication is generated in a second language. Features of the translation and the source communication are analyzed. The translation is correlated with the source communication. Differences are detected between the analyzed features of the correlated translation and source communication. At least one of the translation and the source communication are modified based on the detected differences.

According to an exemplary embodiment of the present inventive concept, a computer program product is provided for synchronizing a translation with source multimedia. The computer program product includes one or more computer-readable storage media and program instructions stored on the one or more non-transitory computer-readable storage media capable of performing a method. The method includes obtaining source multimedia with a source communication in a first language. A translation of the source communication is generated in a second language. Features of the translation and the source communication are analyzed. The translation is correlated with the source communication. Differences are detected between the analyzed features of the correlated translation and source communication. At least one of the translation and the source communication are modified based on the detected differences.

According to an exemplary embodiment of the present inventive concept, a computer system is provided for synchronizing a translation with source multimedia. The system includes one or more computer processors, one or more computer-readable storage media, and program instructions stored on the one or more of the computer-readable storage media for execution by at least one of the one or more processors capable of performing a method. The method includes obtaining source multimedia with a source communication in a first language. A translation of the source communication is generated in a second language. Features of the translation and the source communication are analyzed. The translation is correlated with the source communication. Differences are detected between the analyzed features of the correlated translation and source communication. At least one of the translation and the source communication are modified based on the detected differences.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of computing environment 100, which may be used for synchronizing a translation with source multimedia, in accordance with an exemplary embodiment of the present inventive concept.

FIG. 2 illustrates a flowchart of translation synchronization 200, in accordance with an exemplary embodiment of the present inventive concept.

FIG. 3A illustrates calculated modifications in the translation synchronization 200, in accordance with an exemplary embodiment of the present inventive concept.

FIG. 3B illustrates calculated modifications in the translation synchronization 200, in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION

Exemplary embodiments of the present inventive concept are disclosed hereafter. However, it shall be understood that the scope of the present inventive concept is dictated by the claims. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

Producing the aforementioned translations and/or alternate media types can be highly costly and tedious to manufacture, especially when the source multimedia involves a video component with subtitles and/or closed captions. In the context of translating a source video, audible translations and respective subtitles/closed captions rarely fit the timeline of corresponding source audio and respective subtitles/closed captions due to relative differences in communication length. Mere translation overlay is impossible because the translation elements do not sync with the corresponding source video timeline. For example, overlay source video might not correspond to the translation element(s) presented, and overlaps may occur between adjacent translation segments, creating a crowded, jumbled, and incoherent translation. The present inventive concept provides an advantage of automatically synchronizing a translation with source multimedia.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as translation synchronization 200. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

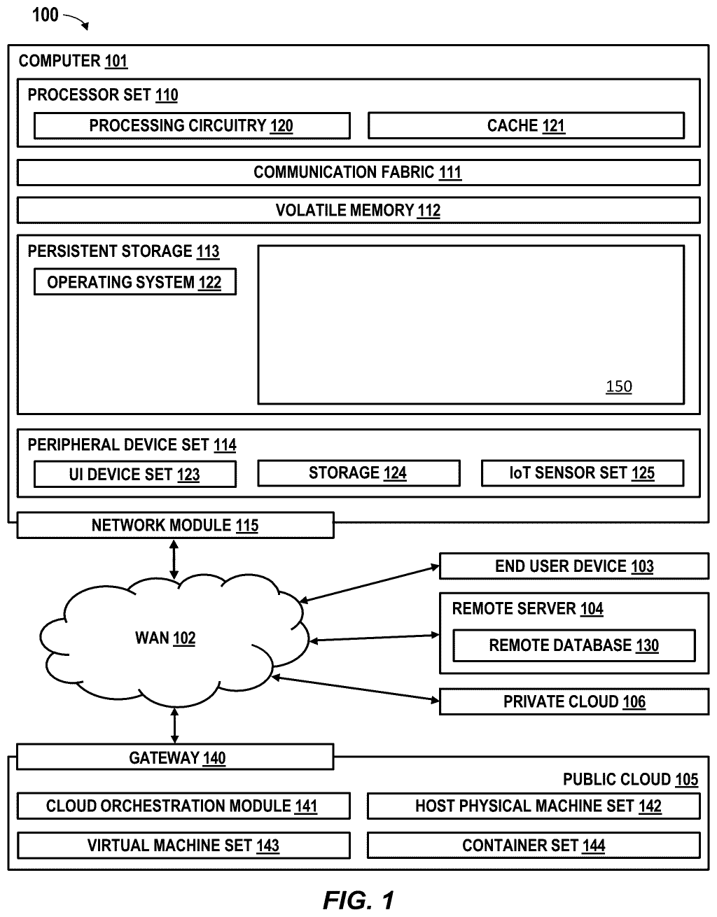

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Furthermore, notwithstanding depiction in computer 101, selective dataset encryption program 150 may be stored in and/or executed by, individually or in any combination, end user device 103, remote server 104, public cloud 105, and private cloud 106.

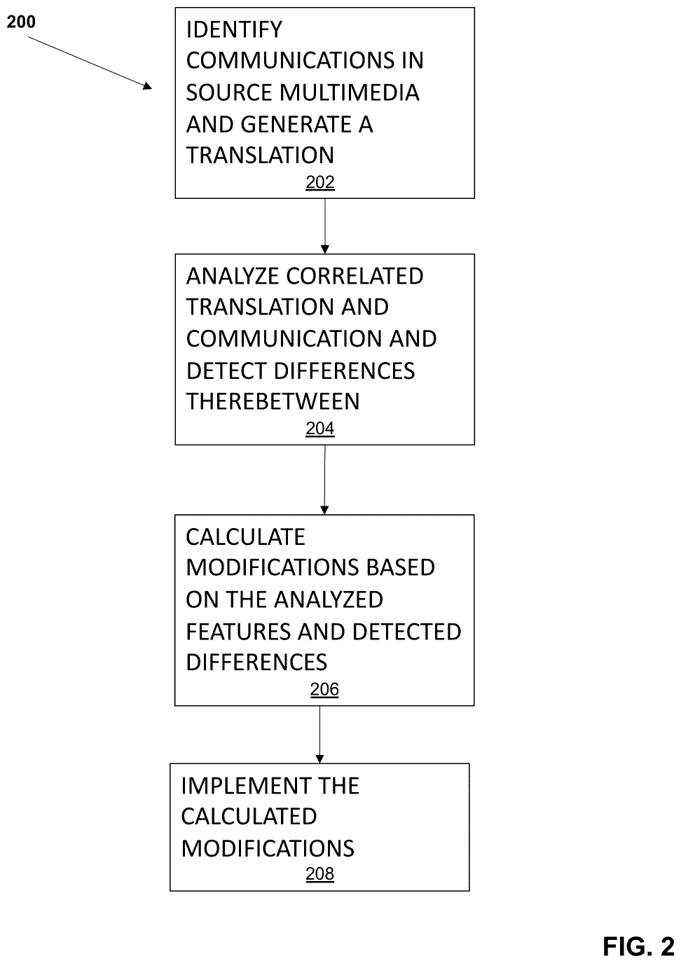

FIG. 2 illustrates a flowchart of synchronizing a translation with source multimedia 200, in accordance with an exemplary embodiment of the present inventive concept.

A translation synchronization program 150 may identify communications in source multimedia and generate a translation in at least one other language (step 202). The translation synchronization program 150 may obtain source multimedia (e.g., audio, video (with or without closed captions), and/or plain text). The source multimedia may include at least one source communication (gestures, speech, text, etc.) in an original language (e.g., Sign, English, Korean, French, Chinese, etc.). The source multimedia may be provided by the user (e.g., recorded, referenced, hyperlinked, uploaded, etc.) and/or automatically retrieved over a network by the translation synchronization program 150 (e.g., by a predetermined keyword search and/or via streaming source multimedia).

A plain text source communication may be translated into the at least one other language without intervening steps. A plain text source communication may also be converted into audio (e.g., an audible communication). The plain text source communication may be given a default video/animation of a comparable spoken length if the source multimedia lacks a video component. Closed captions and/or subtitles may be generated for the default video. The default video/animation may be selected based on a user input topic and/or selected by the translation synchronization program 150 according to a topic of the plain text source communication extracted by machine learning (e.g., natural language processing (NLP)). When the source communication already includes a video component with closed captions and/or subtitles, the translation synchronization program 150 may access the respective subtitle and/or closed caption data files (if available). The translation synchronization program 150 may then analyze the data file contents (e.g., convert relevant code into plain text and/or process the retrieved plain text by NLP). The translation synchronization program 150 may also translate the plain text included in the data file into the at least one other language.

If the source multimedia neither includes plain text nor a video with closed caption or subtitle data files, the translation synchronization program 150 may resort to generating the plain text communication for the source multimedia by first performing machine learning analysis of the source communication. For example, significant gestures (e.g., “signing”) may be analyzed via computer vision; audio may be analyzed with speech to text software and NLP; and graphical text included in video may be analyzed (e.g., using optical character recognition (OCR)) to generate the plain text communication for the obtained multimedia. The plain text (original or generated) may be used to produce closed captions, subtitles, and/or an audible communication (if no audio component) for both the translation in the at least one other language and the source communication. Each caption (e.g., each sentence) may represent a separate audio file (e.g., mp3, way, etc.). The audible communication may be in audio file format and generated using text to speech.

The user may make corrections to the plain text, closed captions, subtitles, and/or manually re-record audible communications. A model of the translation synchronization program 150 may be tuned accordingly.

For example, the translation synchronization program 150 may receive a pre-flight instructional video in English uploaded by an airline representative. The pre-flight video may depict a flight attendant performing safety protocols as described in audio by a separate speaker (not shown). The pre-flight instructional video contains data files for subtitles and closed captions, which are accessed by the translation synchronization program 150 accordingly. The translation synchronization program 150 translates the obtained plain text into French and Mandarin Chinese, respectively. From the translated texts, the translation synchronization program 150 generates audible communications in audio file format using text to speech software.

The translation synchronization program 150 may analyze features of a correlated translation and source communication and detect differences therebetween (step 204). The translation synchronization program 150 may analyze features of the translation and source communication. The analyzed features may include length, pauses, segments, and timestamps (start, end, etc.). The source communication and the corresponding translation may be correlated. The source communication and the translation may both include a plurality of segments. Each segment of the plurality of segments may correspond to audio and/or associated closed captions/subtitles related to at least one word, sentence, speech cluster, etc. The translation synchronization program 150 may correlate corresponding segments of the source communication and the translation according on a synchronized timeline (e.g., start timestamps for each segment of the source communication). The translation synchronization program 150 may compare the analyzed features of the correlated translation and source communication (e.g., overall and with respect to correlated segments) and detect differences therebetween (e.g., length disparities, length ratios, and extent of adjacent segment overlaps). Adjacent segment overlap may occur when the translation component in a correlated segment overlaps a beginning timestamp of another translation component of a sequential correlated segment. The analyzed features, detected differences, and overlaps may be visually presented to the user. The visual presentation may include explanatory annotations (e.g., magnitude value of detected differences, highlighted areas of overlap, etc.).

For example, the pre-flight instructional video in English and the Mandarin Chinese translation may be correlated and have features analyzed to detect differences. The translation synchronization program 150 may identify start timestamps for the English communication and generate a source timeline of audio and corresponding closed caption/subtitles. The translation synchronization program 150 may determine that the audio for first subtitle/closed caption in French is 6.3 seconds long, which overlaps the start timestamp of the second subtitle/caption on the source timeline at 6 seconds by 0.3 seconds. The third caption starts at 22 seconds. The Mandarin Chinese audio translation for the first subtitle/closed caption is similarly approximately 6.3 seconds long, and thus overlaps the start of the second subtitle/closed caption. However, the Mandarin Chinese audio translation for the second subtitle/closed caption is 22 seconds long.

In an embodiment, the translation synchronization program 150 may also detect and/or receive user input regarding audible communication idiosyncrasies/patterns (e.g., atypical speech cadence, enunciations, pauses, etc.). For example, the audible communications may be compared by the translation synchronization program 150 with the audible communications of a cohort of respective native language speakers. Audible communication speech cadence that exceeds or falls below a predetermined speech cadence threshold relative to native language speakers may be identified as a confounding factor in detected differences and/or overlaps. The translation synchronization program 150 may also identify whether audible communications sync with their own associated subtitles/closed captions.

The translation synchronization program 150 may calculate modifications based on the analyzed features and detected differences (step 206). The translation synchronization program 150 may calculate modifications to at least one segment of the translation and/or source communication to mitigate overlap. The modifications to the translation may include at least one of: substituting an audible communication (e.g., using a synthetic voice with a different pace and/or speech cadence); cropping redundancies, improper syntax, and excessive wordiness (intra-segment or in another segment) thus creating or prolonging pause; and speeding up, slowing down, and/or duplicating at least a portion of the correlated corresponding segment for the translation and/or the original language communication. The translation synchronization program 150 may calculate outcomes of implementing potential modifications to the translation (e.g., determine whether overlaps are resolved, exacerbated, and/or introduced) based on the source communication timeline, analyzed pause lengths, analyzed segment lengths, analyzed overlap lengths, etc.

When an overlap exists between a first correlated translation segment and an adjacent, second correlated translation segment, the translation synchronization program 150 may shift (“nudge”) the overlapped second correlated translation segment forwards or backwards by at least the overlap length if the encroached pause length is sufficient to accommodate the nudged second correlated translation segment without introducing or worsening overlap. However, the translation synchronization program 150 may refrain from implementing the nudge if the encroached pause length is insufficient, unless a cascade of nudges to other translated correlated segments can be accomplished without introducing/worsening overlap. The caption synchronization program may additionally or alternatively modify the pace of a correlated translation segment (speed up or slow down) to fit in the synchronized timeline without overlap. The caption synchronization program may reference prior user input and/or lookup tables for the impact of varying levels of pace adjustment on user comprehension and adhere to predetermined thresholds. The caption synchronization program may calculate frame duplication or subtraction (e.g., at predetermined intervals) for a source video based on the analyzed length ratios of correlated corresponding segments. The average correlated corresponding segment ratio for two languages may also be a predetermined value.

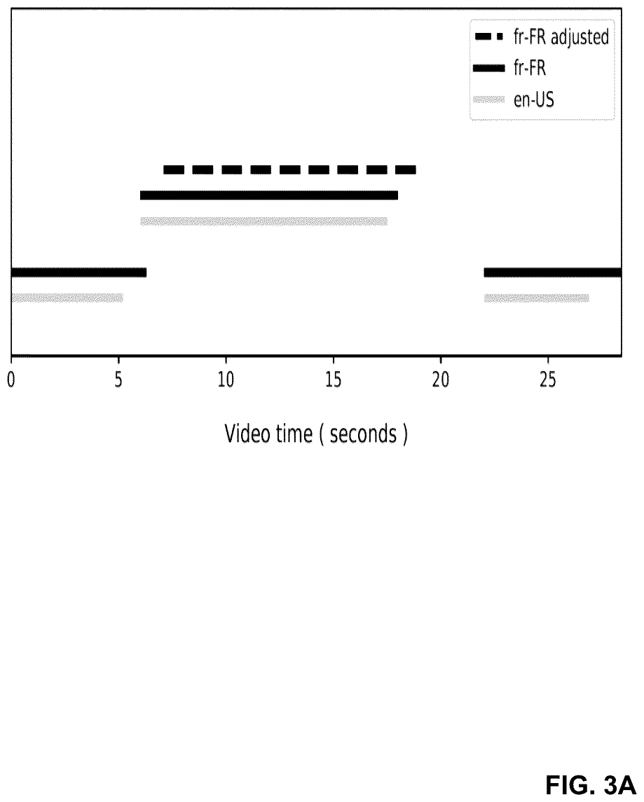

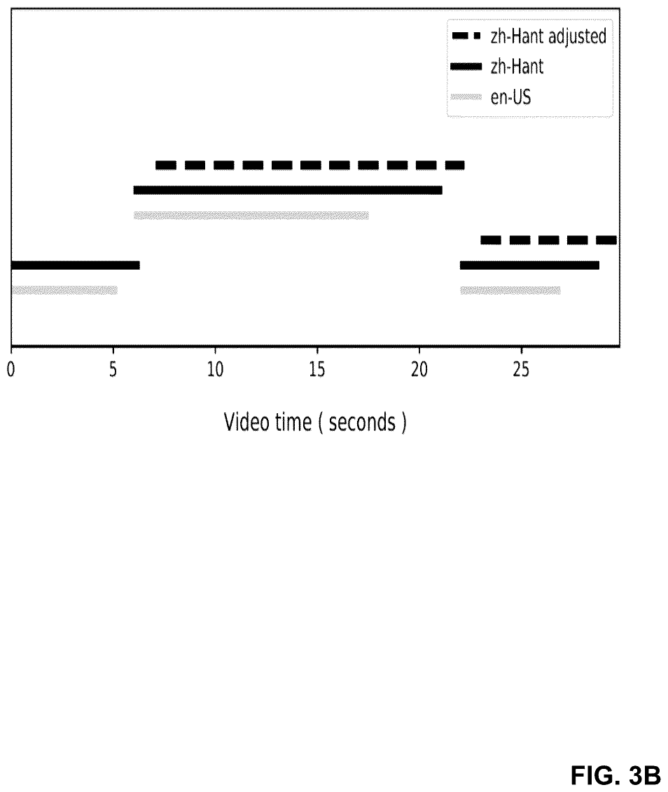

With reference to FIG. 3A, the calculated shift to the audio corresponding to the second subtitle/caption for the French translation of the pre-flight instructional video was viable.

However, with reference to FIG. 3B, the calculated shift to the Mandarin Chinese translation to the pre-flight video was not viable. As illustrated, shifting the translation audio associated with the second subtitle/caption resulted in an overlap with the sequential subtitle/caption. Thus, duplication of the source video was employed. In this case, the translation synchronization program 150 slowed down the source video to make time for the audio. Overall, the Mandarin captions for the Traditional Chinese translation of the transcript text are about 33% longer than the English audio. Thus, the translation synchronization program 150 duplicates every 3rd frame to slow down the source video visuals, and then adjust the audio timestamps.

The caption synchronization program may implement the calculated modifications (step 208). The calculated modifications may be displayed on the source video, a new video, and/or a default/animation video according to the adjusted timeline in conjunction with the translated subtitles/closed captions and/or the translated audible communication. The video may be mp4 format. In an embodiment, a speaker may be depicted in the source and/or default video. The mouth of the speaker may be detected via computer vision and a synthetic mouth voicing the translated audible communication in sync with the translated subtitles/closed captions may be generated. In an embodiment, the caption synchronization program may enable the user to record themselves situated in front of a video backdrop of the source and/or default video, with the translated closed captions synced, while being prompted to read aloud the translated audible communication (e.g., notified of time stamp parameters for each segment) by the translation synchronization program.

For example, using a video library the translation synchronization program 150 generates a new video file of the pre-flight instructional video for the Mandarin Chinese and French translation, respectively. The translation synchronization program 150 produces an .mp4 file with the modifications and adjusted timing (if necessary), and the translated audio files and corresponding subtitles/closed captions are stitched together according to the adjusted timeline.

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

1. A method for synchronizing a translation with source multimedia is provided, the method comprising:
obtaining source multimedia including a source communication in a first language;
generating a translation of the source communication in at least a second language;
analyzing features of the translation and the source communication;
correlating the translation with the source communication;
detecting differences between the analyzed features of the correlated translation and source communication; and
modifying at least one of the translation and the source communication based on the detected differences to synchronize the translation with the source communication.

2. The method of claim 1, wherein the source multimedia includes video of the source communication,
wherein the video of the source communication includes audio and associated closed captions, and
wherein the translation includes audio and associated closed captions.

3. The method of claim 2, wherein the translation and the source communication each include a plurality of segments,
wherein each segment includes audio and associated closed captions, and
wherein the analyzed features include segment lengths.

4. The method of claim 3, wherein the correlating the translation with the source communication is based on a timeline of the source communication.

5. The method of claim 4, wherein the detected differences include differences in the segment lengths of the correlated translation and source communication.

6. The method of claim 5, wherein the modifying at least one of the translation and source communication includes modifying at least one segment thereof.

7. The method of claim 6, wherein the modifying at least one of the translation and source communication is selected from a group consisting of shifting a segment, manipulating segment length, and manipulating segment speed.

8. A computer program product for speech recognition using speech cadence patterns, the computer program product comprising:
one or more computer-readable storage media and program instructions stored on the one or more non-transitory computer-readable storage media capable of performing a method, the method comprising:
obtaining source multimedia including a source communication in a first language;
generating a translation of the source communication in a second language;
analyzing features of the translation and the source communication;
correlating the translation with the source communication;
detecting differences between the analyzed features of the correlated translation and source communication; and
modifying at least one of the translation and the source communication based on the detected differences.

9. The computer program product of claim 8, wherein the source multimedia includes video of the source communication,
wherein the video of the source communication includes audio and associated closed captions, and
wherein the translation includes audio and associated closed captions.

10. The computer program product of claim 9, wherein the translation and the source communication each include a plurality of segments,
wherein each segment includes audio and associated closed captions, and
wherein the analyzed features include segment lengths.

11. The computer program product of claim 10, wherein the correlating the translation with the source communication is based on a timeline of the source communication.

12. The computer program product of claim 11, wherein the detected differences include differences in the segment lengths of the correlated translation and source communication.

13. The computer program product of claim 12, wherein the modifying at least one of the translation and source communication includes modifying at least one segment thereof.

14. The computer program product of claim 13, wherein the modifying at least one of the translation and source communication is selected from a group consisting of shifting a segment, manipulating segment length, and manipulating segment speed.

15. A computer system for speech recognition using speech cadence patterns, the system comprising:
one or more computer processors, one or more computer-readable storage media, and program instructions stored on the one or more of the computer-readable storage media for execution by at least one of the one or more processors capable of performing a method, the method comprising:
obtaining source multimedia including a source communication in a first language;
generating a translation of the source communication in a second language;
analyzing features of the translation and the source communication;
correlating the translation with the source communication;
detecting differences between the analyzed features of the correlated translation and source communication; and
modifying at least one of the translation and the source communication based on the detected differences.

16. The computer system of claim 15, wherein the source multimedia includes video of the source communication,
wherein the video of the source communication includes audio and associated closed captions, and
wherein the translation includes audio and associated closed captions.

17. The computer system of claim 16, wherein the translation and the source communication each include a plurality of segments,
wherein each segment includes audio and associated closed captions, and
wherein the analyzed features include segment lengths.

18. The computer system of claim 17, wherein the correlating the translation with the source communication is based on a timeline of the source communication.

19. The computer system of claim 18, wherein the detected differences include differences in the segment lengths of the correlated translation and source communication.

20. The computer system of claim 19, wherein the modifying at least one of the translation and source communication includes modifying at least one segment thereof.
